(19) United States
(12) Patent Application Publication
(10) Pub. No.: US 2010/0247023 A1
(43) Pub. Date: Sep. 30, 2010

(54) OPTICAL WAVEGUIDE TYPE MODULATOR

(75) Inventors: Yasuhiro Ishikawa, Tokyo (JP); Toru Sugamata, Tokyo (JP)

Correspondence Address: CHAPMAN AND CUTLER, 111 WEST MONROE STREET, CHICAGO, IL, 60603, US

(73) Assignee: Sumitomo Osaka Cement Co., Ltd., Tokyo (JP)

(21) Appl. No.: 12/733,869

(22) PCT Filed: Sep. 25, 2008
(86) PCT No.: PCT/JP2008/067247

§ 371 Date: Jun. 4, 2010

(30) Foreign Application Priority Data
Sep. 28, 2007 (JP) 2007-252846

(51) Int. Cl. G02F 1/035; G02B 6/12

(52) U.S. Cl. 385/2; 385/14

(57) ABSTRACT

An optical waveguide type modulator with a decreased driving voltage and an improved return loss of a driving signal is provided which includes an optical waveguide having a Mach-Zehnder type optical waveguide portion and a signal electrode and a ground electrode modulating an optical wave guided in the optical waveguide. The signal electrode is arranged along at least one of two branched waveguides and Y-branched portions of the Mach-Zehnder type optical waveguide portion and along a part of one Y-branched portion connected to the one branched waveguide. Outside the part of one Y-branched portion, the signal electrode is drawn across a symmetric axis of the Mach-Zehnder type optical waveguide portion with a gap from the one Y-branched portion, and is drawn so as not to extend along the other Y-branched portion connected to the one branched waveguide and so as not to extend across the symmetric axis with a gap from the one branched waveguide.

### BACKGROUND OF THE INVENTION

1. Field of the Invention

The present invention relates to an optical waveguide type modulator, and more particularly, to an optical waveguide type modulator in which an optical waveguide having a Mach-Zehnder type optical waveguide portion and a modulating electrode for modulating an optical wave guided by the optical waveguide are formed on a Z-cut type substrate.

2. Description of Related Art

Recently, in the fields of optical communications or optical measurements, an optical waveguide type modulator in which an optical waveguide is formed on a substrate being formed of lithium niobate or the like and having an electro-optical effect has been used. A Mach-Zehnder type optical waveguide is often used in the optical waveguide type modulator. Particularly, when a so-called Z-cut type substrate is used which has the thickness direction of a substrate (a direction perpendicular to the substrate surface in which the optical waveguide is formed) as a direction in which an electro-optical effect is most efficiently exhibited with the electric field applied to the substrate, a signal electrode or a ground electrode is arranged along a branched waveguide of the Mach-Zehnder type optical waveguide (on the waveguide or on the waveguide with a buffer layer interposed therebetween).

On the other hand, it is very important to reduce a driving voltage for driving the optical waveguide type modulator, for the purpose of decreasing power consumption of the optical modulator and increasing driving frequency. Patent Literature 1 discloses a technique for forming an opening 104 in a central ground electrode 103 so as to suppress the dip in a frequency response characteristic. In Patent Literature 1, as shown in FIG. 5 or 6, signal electrodes 101 and 102 along the optical waveguide are arranged up to parts of Y-branched portions 6 and 9 connected to branched waveguides 7 and 8. In view of a decrease in driving voltage, the arrangement of the signal electrodes up to the parts of the Y-branched portions makes it possible to elongate the region in which the driving voltage is applied to the optical waveguides and thus to reduce the driving voltage. For the purpose of clarifying the explanation, a buffer layer disposed below the signal electrodes or the ground electrodes is not shown and the optical waveguide disposed below the electrodes is transparent. This is true in FIGS. 1 to 4.

Patent Literature 1: PCT Japanese Translation Patent Publication No. WO2004/086126 (see FIG. 5 or 6)

However, as shown in FIG. 5 or 6, even when the signal electrodes are arranged along the optical waveguides of the Y-branched portions, the signal electrodes are rapidly bent and the radius of curvature thereof decreases in a region where the signal electrode is drawn apart from the waveguide (in the drawn portion of the signal electrode). Accordingly, the reflection or the unnecessary leakage into the substrate of micro waves as driving signals occurs in the curved portion of the electrode, thereby causing the deterioration in return loss of the driving signals.

### SUMMARY OF THE INVENTION

An advantage of some aspects of the invention is that it provides an optical waveguide type modulator with a decrease in driving voltage and an improvement in return loss of a driving signal.

According to an aspect of the invention, there is provided an optical waveguide type modulator including: a Z-cut type substrate having an electro-optical effect; an optical waveguide having a Mach-Zehnder type optical waveguide portion formed on the substrate; and a modulating electrode modulating an optical wave guided in the optical waveguide, wherein the Mach-Zehnder type optical waveguide portion includes two branched waveguides and two Y-branched portions and the modulating electrode includes a signal electrode and a ground electrode, and wherein the signal electrode is arranged along at least one of the two branched waveguides, the signal electrode is disposed along a part of the Y-branched portion connected to the one branched waveguide in a region where the signal electrode gets apart from the one branched waveguide and the signal electrode is drawn across a symmetric axis of the Mach-Zehnder type optical waveguide portion, and the signal electrode is disposed so as not to extend along the Y-branched portion connected to the one branched waveguide in a region where the signal electrode is drawn apart from the one branched waveguide and the signal electrode is drawn so as not to extend across the symmetric axis of the Mach-Zehnder type optical waveguide portion.

In the invention, the “branched waveguide” generally means a portion in which two optical waveguides are parallel to each other or the optical waveguides are straight in two optical waveguide portions interposed between two Y-branched portions of the Mach-Zehnder type optical waveguide portion. The “Y-branched portion” includes a branching point and also includes connecting portions in which two optical waveguides branched from the branching point gradually separate from each other and are connected to the branched waveguides.

In the optical waveguide type modulator, a gap between two waveguides of the Y-branched portion at a point where the signal electrode is drawn apart from the Y-branched portion in the region where the signal electrode is disposed along the part of the Y-branched portion may be equal to or greater than 15 μm.

In the optical waveguide type modulator, two signal electrodes may be provided along the two branched waveguides, respectively, and the other signal electrode may be disposed so as not to extend along the Y-branched portion connected to the other branched waveguide in the region where the one signal electrode is drawn apart from the one branched waveguide and the one signal electrode is drawn across the symmetric axis of the Mach-Zehnder type waveguide portion.

In the optical waveguide type modulator, a curved portion for adjusting a delay of a modulated signal may be formed in at least one of the two signal electrodes.

In the optical waveguide type modulator, the two signal electrodes may have the same total length.

In the optical waveguide type modulator, the ground electrode may be arranged along the other branched waveguide and the ground electrode may be arranged along a part of the Y-branched portion connected to the other branched waveguide in the region where the signal electrode is drawn apart from the one branched waveguide and the signal electrode is drawn across the symmetric axis of the Mach-Zehnder type waveguide portion.

According to the above-mentioned configuration, the signal electrode is arranged along a part of the Y-branched portion connected to the one branched waveguide in the region where the signal electrode is drawn apart from the one branched waveguide and the signal electrode is drawn across the symmetric axis of the Mach-Zehnder type optical waveguide portion. Accordingly, in the Y-branched portion, it is also possible to modulate the optical wave guided in the optical waveguide while bending the signal electrode in the direction in which the signal electrode is drawn. The length of the optical waveguide (referred to as “operating portion”) affected by the modulation increases, thereby decreasing the driving voltage of the optical waveguide type modulator. In addition, since the signal electrode is bent in the drawing direction, it is possible to suppress the deterioration in return loss without rapidly reducing the curvature.

According to the above-mentioned configuration, the signal electrode is disposed so as not to extend along the Y-branched portion connected to the one branched waveguide in the region where the signal electrode is drawn apart from the one branched waveguide and the signal electrode is drawn so as not to extend across the symmetric axis of the Mach-Zehnder type optical waveguide portion. Accordingly, it is possible to suppress the deterioration in return loss without rapidly reducing the curvature at the time of drawing the signal electrode. Particularly, as described in Patent Literature 1, very small curvature is necessary for drawing the signal electrode so as not to extend across the symmetric axis of the Mach-Zehnder type optical waveguide portion after arranging the signal electrode along the part of the Y-branched portion, but such a problem is not caused in the invention.

According to the above-mentioned configuration, the gap between two waveguides of the Y-branched portion at a point where the signal electrode is drawn apart from the Y-branched portion in the region where the signal electrode is disposed along the part of the Y-branched portion is equal to or greater than 15 μm. Accordingly, it is possible to suppress the crosstalk between the waveguides caused due to the influence of the electric field of the signal electrode on two waveguides.

According to the above-mentioned configuration, two signal electrodes are provided along the two branched waveguides, respectively, and the other signal electrode is disposed so as not to extend along the Y-branched portion connected to the other branched waveguide in the region where the one signal electrode is drawn apart from the one branched waveguide and the one signal electrode is drawn across the symmetric axis of the Mach-Zehnder type waveguide portion. Accordingly, in the optical waveguide type modulator employing two signal electrodes, it is also possible to reduce the driving voltage and to improve the return loss of the driving signal.

According to the above-mentioned configuration, the curved portion for adjusting a delay of a modulated signal is formed in at least one of the two signal electrodes. Accordingly, it is possible to adjust the modulation phase or the modulation time between the operating portions of the optical waveguides resulting from two signal electrodes.

According to the above-mentioned configuration, two signal electrodes have the same total length. Accordingly, it is possible to keep constant the attenuation of the modulated signal applied to the signal electrodes in the two signal electrodes and to adjust the impedance of the signal electrodes in the same way.

According to the above-mentioned configuration, the ground electrode is arranged along the other branched waveguide and the ground electrode is arranged along a part of the Y-branched portion connected to the other branched waveguide in the region where the signal electrode is drawn apart from the one branched waveguide and the signal electrode is drawn across the symmetric axis of the Mach-Zehnder type waveguide portion. Accordingly, it is possible to have an influence of the modulation on the waveguide in which the ground electrode is formed for a longer time and to further reduce the driving voltage.

### BRIEF DESCRIPTION OF THE DRAWINGS

FIG. 1 is a diagram illustrating an optical waveguide type modulator according to a first embodiment of the invention.

FIG. 2 is a partially-enlarged view of a Y-branched portion shown in FIG. 1.

FIG. 3 is a diagram illustrating an optical waveguide type modulator according to a second embodiment of the invention.

FIG. 4 is a partially-enlarged view of a Y-branched portion shown in FIG. 3.

FIG. 5 is diagram illustrating an example disclosed in Patent Literature 1.

FIG. 6 is a diagram illustrating another example disclosed in Patent Literature 1.

### EXPLANATION OF REFERENCES

1 substrate
2, 21, 22 signal electrodes
3, 4, 31-33 ground electrodes
5-10 optical waveguide

### DETAILED DESCRIPTION OF THE INVENTION

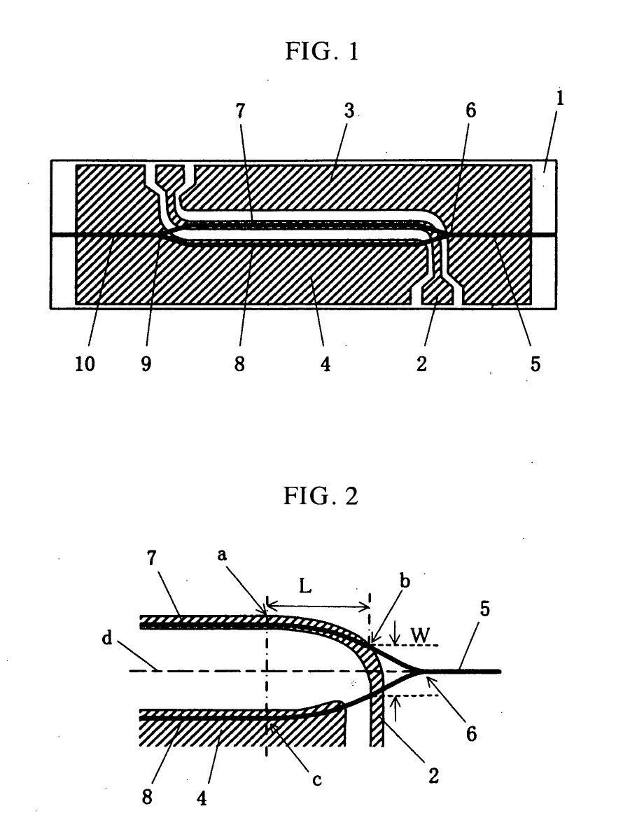

Hereinafter, an optical waveguide type modulator according to exemplary embodiments of the invention will be described in detail. The optical waveguide type modulator according to a first embodiment of the invention is shown in FIGS. 1 and 2. FIG. 2 is a partially-enlarged view of a Y-branched portion on the right side in FIG. 1, and a buffer layer or a ground electrode 3 is not shown for the purpose of facilitating understanding. An optical waveguide type modulator includes a Z-cut type substrate 1 having an electro-optical effect, an optical waveguide 5 to 10 having a Mach-Zehnder type optical waveguide portion formed on the substrate, and a modulating electrode modulating an optical wave guided in the optical waveguide. The Mach-Zehnder type optical waveguide portion includes two branched waveguides 7 and 8 and two Y-branched portions 6 and 9 and the modulating electrode includes a signal electrode 2 and ground electrodes 3 and 4. The signal electrode 2 is arranged along one branched waveguide 7, the signal electrode is disposed along a part of the Y-branched portion connected to the one branched waveguide in a region where the signal electrode is drawn apart from the one branched waveguide and the signal electrode is drawn across a symmetric axis d of the Mach-Zehnder type optical waveguide portion, and the signal electrode is disposed so as not to extend along the Y-branched portion connected to the one branched waveguide in a region where the signal electrode is drawn apart from the one branched waveguide and the signal electrode is drawn so as not to extend across the symmetric axis of the Mach-Zehnder type optical waveguide portion.

In the invention, the “branched waveguide” generally means a portion (the left portion of a one-dot chained line including points a and c in FIG. 2) in which two optical waveguides are parallel to each other or the optical waveguides are straight in two optical waveguides 7 and 8 interposed between two Y-branched portions of the Mach-Zehnder type optical waveguide portion. The “Y-branched portion” includes a branching point and also includes connecting portions (a portion from the right portion of the one-dot chained line including points a and c to the branching point in FIG. 2) in which two optical waveguides branched from the branching point gradually separate from each other and are connected to the branched waveguides.

The substrate 1 can be formed of, for example, lithium niobate, lithium tantalite, PLZT (Lead Lanthanum Zirconate Titanate), silica material, or combinations thereof. Particularly, crystals of lithium niobate (LN) or lithium tantalite (LT) having a high electro-optical effect can be properly employed.

The optical waveguides can be formed by diffusing Ti or the like into the surface of the substrate using a thermal diffusion method or a proton-exchange method.

The modulating electrodes such as the signal electrode and the ground electrodes can be formed by forming electrode patterns of TiAu or by using a gold plating method.

Although not particularly shown, a buffer layer of SiO₂ or the like can be preferably formed between the substrate 1 and the modulating electrodes. Particularly, when the Z-cut type substrate is used as in the invention, the modulating electrodes need to be formed above the optical waveguide. Accordingly, the buffer layer is formed to prevent the optical wave propagated by the optical waveguide from being absorbed or scattered by the modulating electrodes.

In the optical waveguide type modulator according to the first embodiment of the invention, as shown in FIG. 2, the signal electrode 2 is arranged along a part (a region indicated by points a to b and arrow L) of the Y-branched portion connected to one branched waveguide in the region (the left region of point a in FIG. 2) where the signal electrode 2 is drawn apart from one branched waveguide and the signal electrode is drawn across the symmetric axis d of the Mach-Zehnder type optical waveguide portion. Accordingly, in the Y-branched portion, it is also possible to modulate the optical wave guided in the optical waveguide while bending the signal electrode in the direction in which the signal electrode is drawn. The length of the optical waveguide (operating portion) affected by the modulation increases by the amount indicated by reference sign L, thereby decreasing the driving voltage of the optical waveguide type modulator. In addition, since the signal electrode 2 is bent in the drawing direction (downward in the drawing), it is possible to suppress the deterioration in return loss without rapidly reducing the curvature.

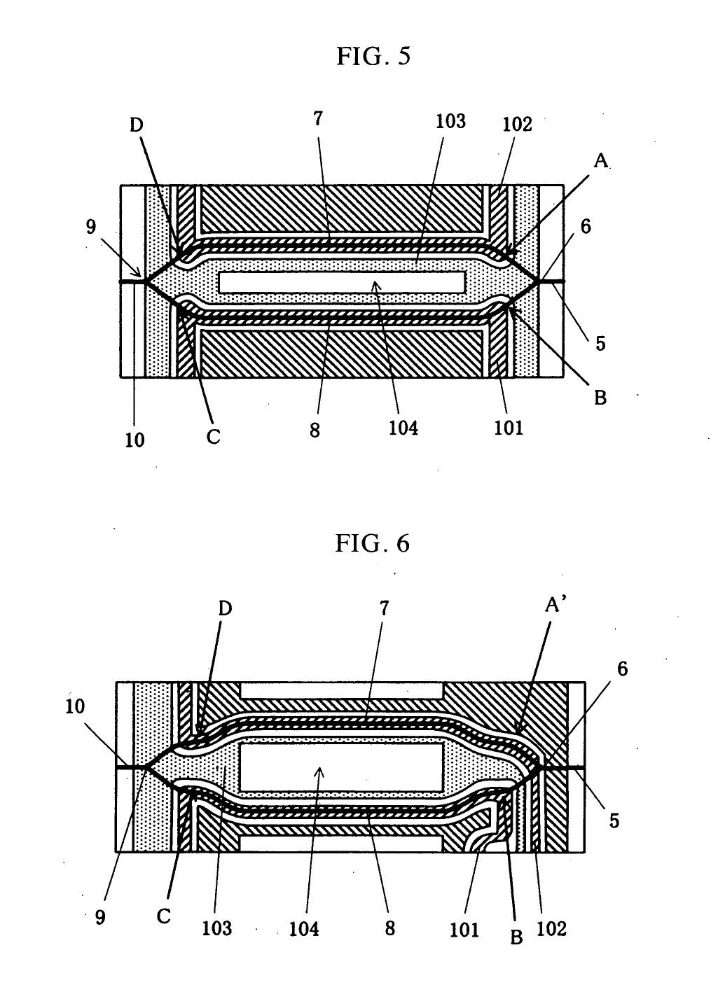

When the signal electrode 2 is drawn in the vicinity of the Y-branched portion 9 as shown in FIG. 1, similarly to a signal electrode 22 shown in FIG. 4, the signal electrode is disposed so as not to extend along the Y-branched portion connected to the one branched waveguide in the region where the signal electrode is drawn apart from the one branched waveguide and the signal electrode is drawn so as not to extend across the symmetric axis of the Mach-Zehnder type optical waveguide portion. Accordingly, for example, as indicated by reference signs A to D in FIG. 5 or 6, it is not necessary to reduce the curvature at the time of drawing the signal electrode, thereby suppressing the deterioration in return loss.

In the optical waveguide type modulator according to the embodiment of the invention, as shown in FIG. 2, the ground electrode 4 is arranged along the other branched waveguide 8 and the ground electrode is arranged along a part (the right portion of point c in FIG. 2) of the Y-branched portion connected to the other branched waveguide 8 in the region where the signal electrode 2 is drawn apart from one branched waveguide 7 and the signal electrode is drawn across the symmetric axis d of the Mach-Zehnder type waveguide portion. Accordingly, in the right portion of point c in FIG. 2 outside the branched waveguide, the ground electrode 4 is formed in the waveguide and the modulation has an influence on the waveguide below the ground electrode, thereby further reducing the driving voltage.

In the optical waveguide type modulator according to the embodiment of the invention, a gap W between two waveguides of the Y-branched portion at a point (point b in FIG. 2) where the signal electrode is drawn apart from the Y-branched portion in the region where the signal electrode is disposed along a part of the Y-branched portion is equal to or greater than 15 μm. When the gap W decreases, the electric field formed by the signal electrode 2 has an influence on two waveguides, that is, the waveguide (the optical waveguide from point c to the branching point) below the Y-branched portion as well as the waveguide (the optical waveguide from point a to the branching point) above the Y-branched portion, thereby causing the crosstalk between two waveguides. As shown in FIG. 2, by setting the gap W to be equal to or greater than 15 μm, it is possible to effectively suppress the crosstalk.

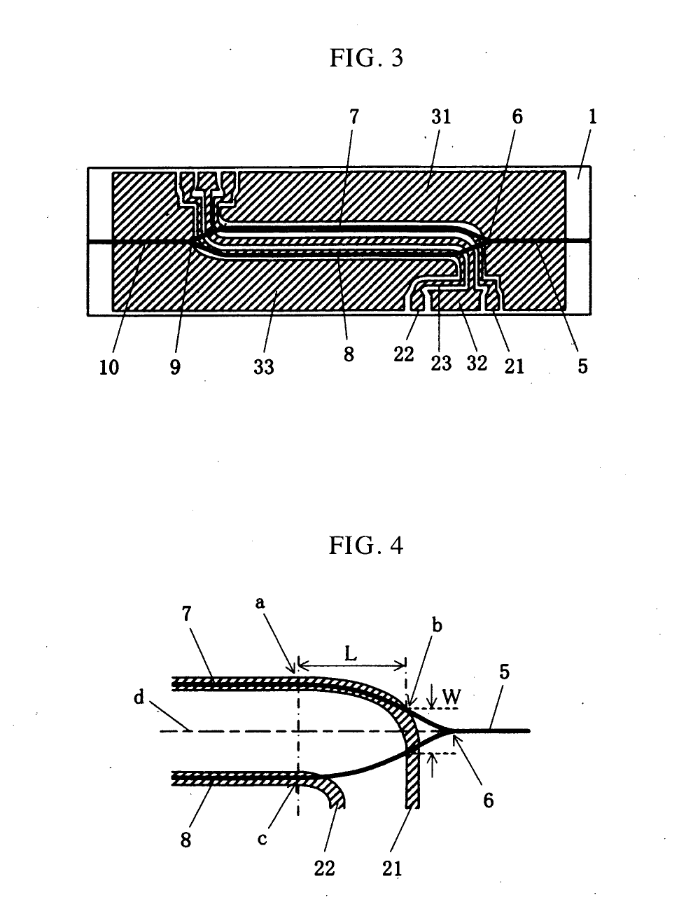

An optical waveguide type modulator according to a second embodiment of the invention is shown in FIGS. 3 and 4. FIG. 4 is a partially-enlarged view of the Y-branched portion on the right in FIG. 3, and ground electrodes 31 to 33 are not shown for the purpose of facilitating understanding.

The second embodiment provides a so-called dual light modulator in which independent signal electrodes 21 and 22 are disposed to correspond to the branched waveguides 7 and 8.

In the second embodiment, similarly to the first embodiment, the optical waveguide type modulator includes a Z-cut type substrate 1 having an electro-optical effect, an optical waveguide 5 to 10 having a Mach-Zehnder type optical waveguide portion formed on the substrate, and a modulating electrode modulating an optical wave guided in the optical waveguide. The Mach-Zehnder type optical waveguide portion includes two branched waveguides 7 and 8 and two Y-branched portions 6 and 9 and the modulating electrode includes signal electrodes 21 and 22 and ground electrodes 31 to 33. The signal electrodes 21 and 22 are arranged along the branched waveguides 7 and 8, the signal electrodes are disposed along parts of the Y-branched portion connected to the branched waveguides in a region (in the vicinity of the Y-branched portion 6 regarding the signal electrode 21 and in the vicinity of the Y-branched portion 9 regarding the signal electrode 22) where the signal electrodes 21 and 22 are drawn apart from the branched waveguides 7 and 8, and the signal electrode is drawn across the symmetric axis d of the Mach-Zehnder type optical waveguide portion (in the range from point a to point b in FIG. 4), and the signal electrodes are disposed so as not to extend along the Y-branched portion connected to the branched waveguide in the region (in the vicinity of the Y-branched portion 9 regarding the signal electrode 21 and in the vicinity of the Y-branched portion 6 regarding the signal electrode 22) where the signal electrodes 21 and 22 are drawn apart from the branched waveguides 7 and 8 and the signal electrode is drawn so as not to extend across the symmetric axis d of the Mach-Zehnder type optical waveguide portion (see the signal electrode 22 in FIG. 4).

Similarly to FIG. 2 of the first embodiment, in FIG. 4 of the second embodiment, it is possible to reduce the driving voltage with the increase in length L of the region (the range from point a to point b) in which the signal electrode 21 is disposed along the Y-branched portion. The waveguide gap W at point b where the signal electrode 21 is drawn apart from the Y-branched portion is preferably set to be equal to or greater than 15 μm so as to suppress the crosstalk, similarly to the first embodiment.

In the second embodiment, two signal electrodes 21 and 22 are provided along two branched waveguides 7 and 8, respectively, and the other signal electrode 22 is disposed so as not to extend along the Y-branched portion connected to the other branched waveguide 8 in the region (the right region of the one-dot chained line including point a and point c in FIG. 4) where one signal electrode 21 is drawn apart from one branched waveguide and the one signal electrode is drawn across the symmetric axis d of the Mach-Zehnder type waveguide portion. Accordingly, in the optical waveguide type modulator employing two signal electrodes, it is also possible to reduce the driving voltage and to improve the return loss of the driving signal.

In the second embodiment, as shown in FIG. 3, a curved portion 23 for adjusting a delay of a modulated signal is formed in at least one side (22) of two signal electrodes. Accordingly, it is possible to adjust the modulation phase or the modulation time between the operating portions of the optical waveguides resulting from two signal electrodes 21 and 22, for example, at points a and c in FIG. 4.

Since two signal electrodes 21 and 22 have the same total length, it is possible to keep constant the attenuation of the modulated signal applied to the signal electrodes between the two signal electrodes and to adjust the impedance of the signal electrodes in the same way.

The position where the signal electrode is drawn in and the potion where the signal electrode is drawn out in the optical waveguide type modulator according to the embodiment of the invention are not limited to positions close to different sides of the substrate 1 shown in FIG. 1 or 3, but may be located in the same side of the substrate 1. As shown in FIG. 3, when the input and the output of the signal electrode are located on the different sides of the substrate, it is possible to equalize the lengths of the operating portions allowing the signal electrodes to apply the electric field to the optical waveguides and to equalize the modulating situation of the branched waveguides, by configuring the other Y-branched portion 9 in the same way as shown in FIG. 4 (however, the signal electrodes 21 and 22 are exchanged). It is also possible to suppress a chirp phenomenon resulting from the different modulating situations of the branched waveguides.

In description of the invention, the traveling direction of the optical wave in the optical waveguide modulator or the traveling direction of the modulated signal is not particularly described. However, the invention is advantageous when the optical wave or the modulated signal travels to any of the left and right sides of FIG. 1 or 3.

According to the invention, it is possible to provide an optical waveguide type modulator with a decreased driving voltage and an improved return loss of a driving signal.

1. An optical waveguide type modulator comprising:
a Z-cut type substrate having an electro-optical effect;
an optical waveguide having a Mach-Zehnder type optical waveguide portion formed on the substrate; and
a modulating electrode modulating an optical wave guided in the optical waveguide,
wherein the Mach-Zehnder type optical waveguide portion includes two branched waveguides and two Y-branched portions and the modulating electrode includes a signal electrode and a ground electrode, and
wherein the signal electrode is arranged along at least one of the two branched waveguides, the signal electrode is disposed along a part of the Y-branched portion connected to the one branched waveguide in a region where the signal electrode is drawn apart from the one branched waveguide and the signal electrode is drawn across a symmetric axis of the Mach-Zehnder type optical waveguide portion, and the signal electrode is disposed so as not to extend along the Y-branched portion connected to the one branched waveguide in a region where the signal electrode is drawn apart from the one branched waveguide and the signal electrode is drawn so as not to extend across the symmetric axis of the Mach-Zehnder type optical waveguide portion.

2. The optical waveguide type modulator according to claim 1, wherein a gap between two waveguides of the Y-branched portion at a point where the signal electrode is drawn apart from the Y-branched portion in the region where the signal electrode is disposed along the part of the Y-branched portion is equal to or greater than 15 μm.

3. The optical waveguide type modulator according to claim 1, wherein two signal electrodes are provided along the two branched waveguides, respectively, and the other signal electrode is disposed so as not to extend along the Y-branched portion connected to the other branched waveguide in the region where the one signal electrode is drawn apart from the one branched waveguide and the one signal electrode is drawn across the symmetric axis of the Mach-Zehnder type waveguide portion.

4. The optical waveguide type modulator according to claim 3, wherein a curved portion for adjusting a delay of a modulated signal is formed in at least one of the two signal electrodes.

5. The optical waveguide type modulator according to claim 3, wherein the two signal electrodes have the same total length.

6. The optical waveguide type modulator according to claim 1, wherein the ground electrode is arranged along the other branched waveguide and the ground electrode is arranged along a part of the Y-branched portion connected to the other branched waveguide in the region where the signal electrode is drawn apart from the one branched waveguide and the signal electrode is drawn across the symmetric axis of the Mach-Zehnder type waveguide portion.

7. The optical waveguide type modulator according to claim 2, wherein two signal electrodes are provided along the two branched waveguides, respectively, and the other signal electrode is disposed so as not to extend along the Y-branched portion connected to the other branched waveguide in the region where the one signal electrode is drawn apart from the one branched waveguide and the one signal electrode is drawn across the symmetric axis of the Mach-Zehnder type waveguide portion.

8. The optical waveguide type modulator according to claim 4, wherein the two signal electrodes have the same total length.

9. The optical waveguide type modulator according to claim 2, wherein the ground electrode is arranged along the other branched waveguide and the ground electrode is arranged along a part of the Y-branched portion connected to the other branched waveguide in the region where the signal electrode is drawn apart from the one branched waveguide and the signal electrode is drawn across the symmetric axis of the Mach-Zehnder type waveguide portion.
